(19) United States
(12) Patent Application Publication
(10) Pub. No.: US 2026/0160224 A1
(43) Pub. Date: Jun. 11, 2026

(54) Assembly for a Vehicle

(71) Applicant: AGCO do Brasil Soluções Agrícolas Ltda., Jundiaí (BR)

(72) Inventors: Henrique Sarti, Mogi das Cruzes (BR); Rafael Teixeira Viana, Mogi das Cruzes (BR); Thiago Marques Grande, Mogi das Cruzes (BR)

(21) Appl. No.: 19/178,660

(22) Filed: Apr. 14, 2025

(30) Foreign Application Priority Data
May 27, 2024 (GB) 2407505.3

(51) Int. Cl. F02M 35/024

(52) U.S. Cl. CPC F02M 35/02416

(57) ABSTRACT

An assembly for a vehicle includes a heat exchanger assembly having a first face; an engine air intake filter having a housing; a bracket extending across the first face of the heat exchanger assembly; a filter mount rotatably connected to the bracket and coupled to the housing of the air intake filter. The filter mount is rotatable relative to the bracket about a rotation axis orthogonal to the first face of the heat exchanger assembly.

### CROSS-REFERENCE TO RELATED APPLICATION

This application claims the benefit of the filing date of U. K. Patent Application 2407505.3, “Assembly for a Vehicle,” filed May 27, 2024, the entire disclosure of which is incorporated herein by reference.

### FIELD

The present disclosure relates generally to an assembly for a vehicle.

### BACKGROUND

A challenge in vehicle design is how to arrange a large number of parts in a restricted engine space while maintaining adequate operation. Accommodating the requirements for an air intake filter together with those for a heat exchanger assembly, both of which require substantial space to enable airflows to be provided for the engine itself and a cooling system for the engine and related components respectively, can be problematic. This is particularly relevant for agricultural vehicles such as tractors, which require large airflows in combination with a restricted engine space. This poses design challenges in relation to assembly, operation and maintenance. One requirement for design of an air intake filter in particular is the need to be able to obtain access to the filter for cleaning and replacement.

### BRIEF SUMMARY

In some embodiments, an assembly for a vehicle includes a heat exchanger assembly having a first face; an engine air intake filter having a housing; a bracket extending across the first face of the heat exchanger assembly; and a filter mount rotatably connected to the bracket and coupled to the housing of the air intake filter. The filter mount is rotatable relative to the bracket about a rotation axis orthogonal to the first face of the heat exchanger assembly.

The filter mount may be rotatable between first and second orientations, wherein the housing of the air intake filter obscures a smaller area of the first face of the heat exchanger assembly in the first orientation.

The filter housing may have a generally cylindrical shape, with a longitudinal axis of the filter housing being oriented vertically in the first orientation. The longitudinal axis of the filter housing may be oriented horizontally in the second orientation.

The air intake filter may comprise a detachable air inlet and a detachable air outlet.

The housing of the air intake filter may comprise a removable cap.

The filter mount may be connected to the bracket about a bearing.

The assembly may comprise a clamping mechanism configured to secure the filter mount to the bracket in the first orientation. The clamping mechanism may be configured to secure the mount to the bracket in the second orientation. The clamping mechanism may comprise a toggle latch. The toggle latch may comprise a first part with a lever and loop attached to the bracket and a second part comprising a hook attached to the filter mount. The second part of the toggle latch may comprise a first hook connectable to the first part with the filter mount in the first orientation and a second hook connectable to the first part with the filter mount in the second orientation.

The clamping mechanism may comprise a locking pin configured to secure the first part in position.

The filter mount may comprise a mounting plate having first and second mounting points to secure the mounting plate to the filter housing.

The filter may comprise a strap extending around the filter housing and configured to connect to the mounting plate.

In an embodiment, there is provided a vehicle engine assembly comprising the above-described assembly.

The vehicle engine assembly may comprise an engine support structure, the bracket being attached to the engine support structure at opposing ends of the bracket.

In an embodiment, a vehicle comprises the vehicle engine assembly. The vehicle may be a tractor.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments will now be described, by way of example only, with reference to the accompanying drawings, in which:

FIG. 1 is a drawing of an example design for an assembly comprising an air intake filter and heat exchanger assembly for a vehicle;

FIG. 2 is a drawing of an example design for an assembly comprising a rotatable air intake filter;

FIG. 3 is a side perspective view drawing of the air intake filter and bracket of FIG. 2;

FIG. 4a is a side elevation view drawing of the bracket and rotatable filter mount of the assembly of FIG. 2 with the filter mount in a first orientation;

FIG. 4b is a side elevation view drawing of the bracket and rotatable filter mount of the assembly of FIG. 2 with the filter mount in a second orientation;

FIG. 5 is a side perspective view of an example bracket and filter mount with the filter mount in a first orientation;

FIG. 6 is a side perspective view of an example bracket and filter mount with the filter mount in a second orientation;

FIG. 7a is a front elevation view drawing of an engine assembly comprising the assembly of FIG. 2 with the air intake filter in a first orientation for operation;

FIG. 7b is a front elevation view drawing of the engine assembly of FIG. 7a with the air intake filter in rotated orientation;

FIG. 7c is a front elevation view drawing of the engine assembly of FIG. 7a with the air intake filter removed; and

FIG. 8 is a schematic side elevation view drawing of an example vehicle.

### DETAILED DESCRIPTION

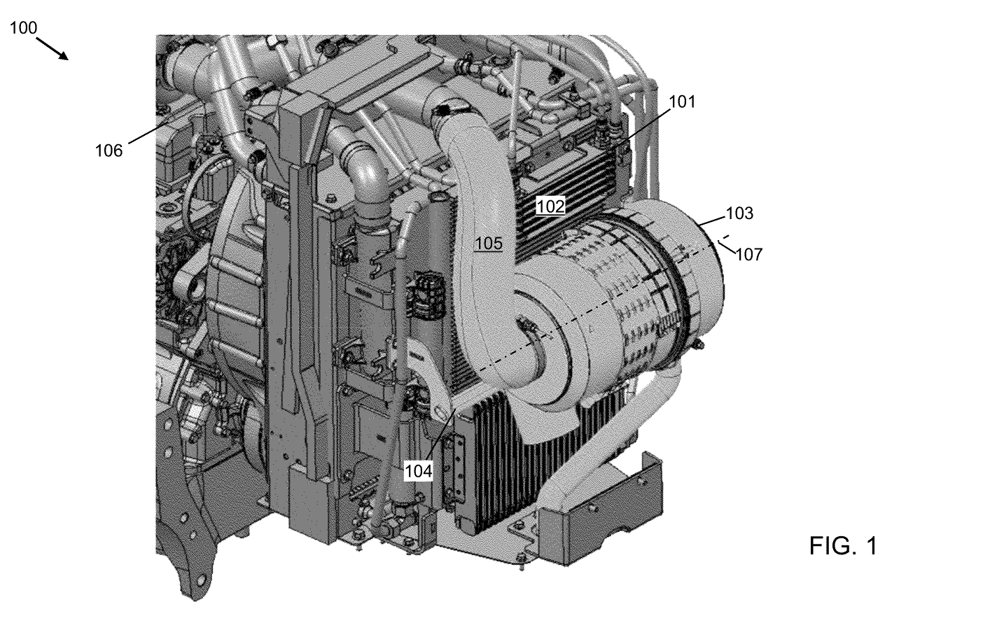

An example assembly 100 for a vehicle is illustrated in FIG. 1. The assembly 100 comprises a heat exchanger assembly 101 or cooling package having a front face 102 through which an airflow is provided during operation of the vehicle to provide cooling for the engine and associated equipment. The heat exchanger assembly 101 may comprise multiple heat exchangers serving different cooling purposes for the engine and associated components. The heat exchanger assembly 101 may for example comprise one or more heat exchangers operating as one or more of a fuel cooler, oil cooler, water cooler, air cooler, transmission fluid cooler and hydraulic fluid cooler. Each of these cooling functions requires an air flow to be provided through a heat exchanger. Multiple heat exchangers may be assembled together as a heat exchanger assembly to receive a common air flow.

The assembly 100 further comprises an engine air intake filter 103, which is connected to a bracket 104 extending across the front face 102 of the heat exchanger assembly 101. An air outlet 105 of the filter 103 directs filtered air towards the engine 106, which is located behind the heat exchanger assembly 101. The filter 103, which may be generally cylindrical in shape, is mounted with a longitudinal axis 107 oriented horizontally due to need to access the filter 103 from the side of the engine compartment for maintenance. A problem with this arrangement is that the filter 103 partially obscures and thereby restricts airflow provided to the front face 102 of the heat exchanger assembly 101, reducing the cooling efficiency of the obscured parts of the heat exchanger assembly 101 during operation. Space restrictions within the engine compartment may not, however, allow for the filter 103 to be relocated or reoriented to a position where the heat exchanger assembly 101 is not obscured or is less obscured.

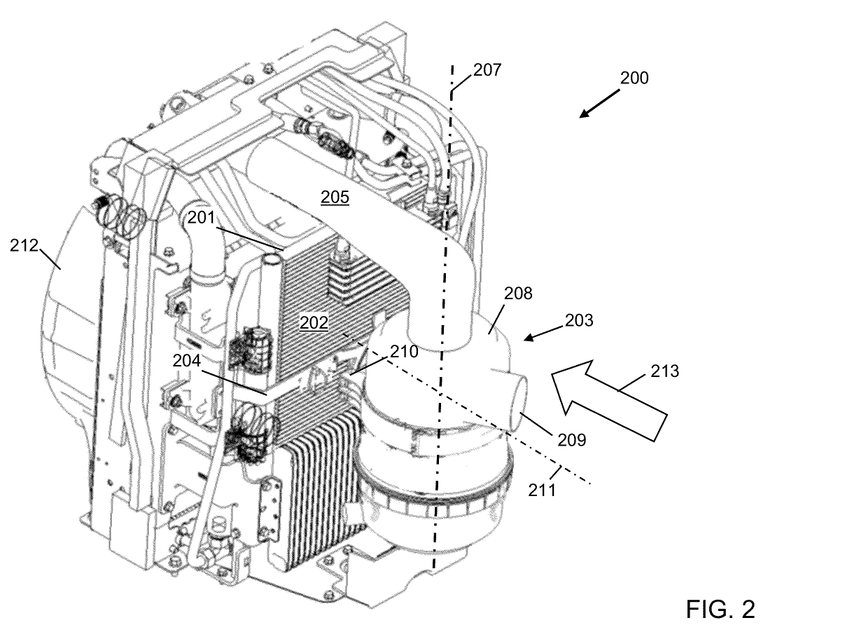

FIG. 2 illustrates an example assembly 200 for a vehicle in which the air intake filter 203 is instead mounted with its longitudinal axis 207 oriented vertically in use. As with the assembly of FIG. 1, the assembly 200 comprises a heat exchanger assembly 201 having a first, or front, face 202 for receiving an airflow to provide engine cooling. The heat exchanger assembly 201 may comprise one or both of a condenser and a radiator for the vehicle, the condenser being part of an air conditioning system and the radiator providing part of an engine cooling system. Other cooling functions may also or alternatively be provided by the heat exchanger assembly 201, as mentioned above. A fan 212, in this example positioned behind the heat exchanger assembly 201, draws a cooling airflow 213 through the heat exchanger assembly 202. A general direction of airflow 213 is indicated in FIG. 2. In alternative arrangements the airflow may be reversed, i.e., the filter 203 is instead provided behind the heat exchanger assembly 201. The general principle of the filter 203 obscuring a portion of the heat exchanger assembly 201, however, remains the same.

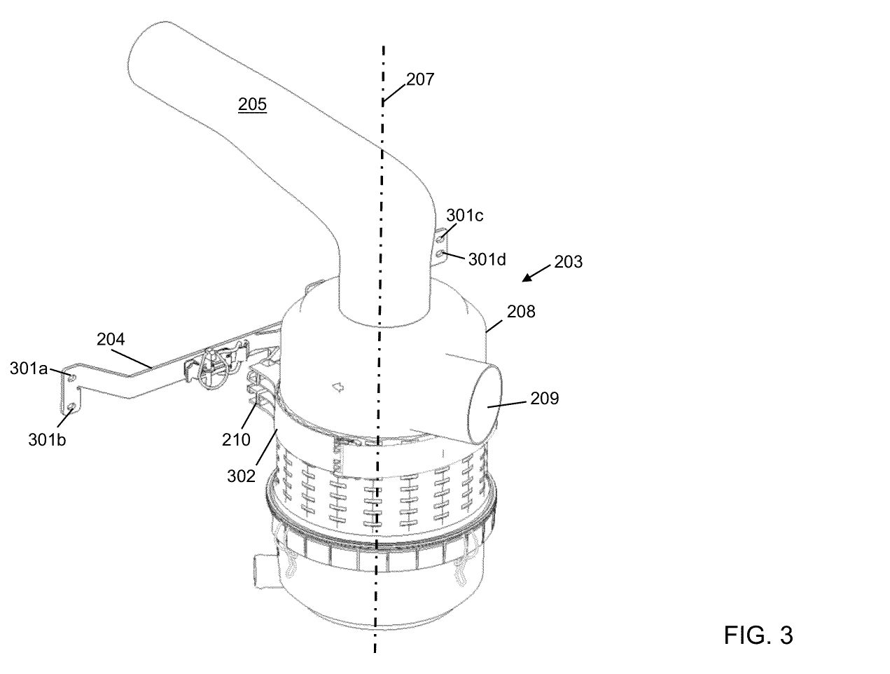

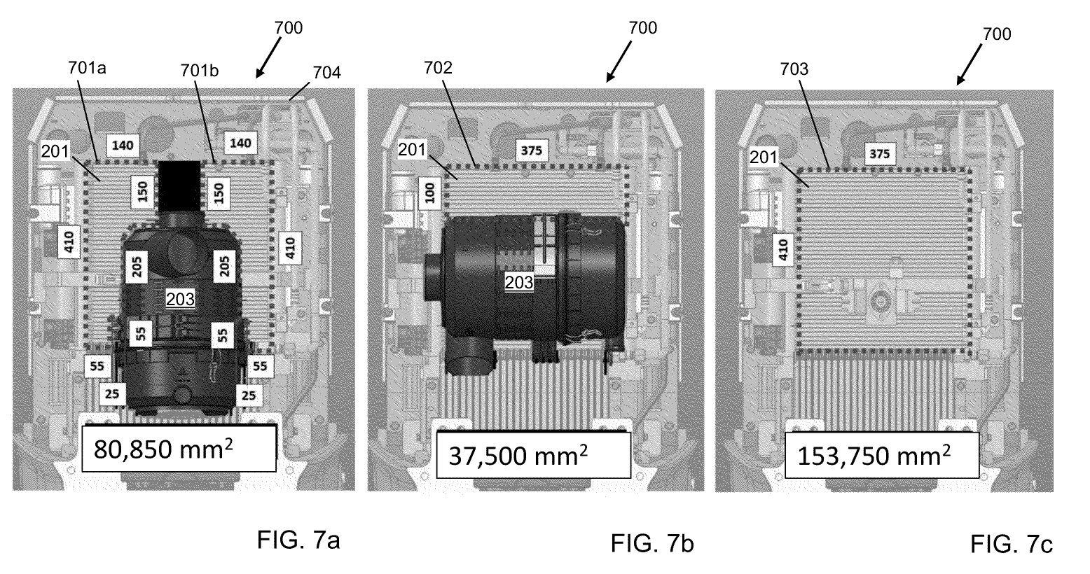

The air intake filter 203 comprises a housing 208, an air outlet 205 for providing filtered air to the engine, and an air inlet 209. The filter 203 is mounted to the bracket 204 with a rotatable filter mount 210, which is described in more detail below. The bracket 204 extends across the face 202 of the heat exchanger assembly 201 and may comprise mounting points (shown in more detail in FIG. 3) at opposing ends that allow the bracket 204 to be mounted to an engine support structure (for example shown in FIG. 7a). The filter mount 210 is rotatable relative to the bracket 204 about a rotation axis 211 that is oriented orthogonal to a plane of the inlet face 202 of the heat exchanger assembly 201.

FIG. 3 illustrates the engine air intake filter 203, bracket 204 and rotatable filter mount 210 separate from the heat exchanger assembly 201 and other components of FIG. 2, showing certain components in more detail. The bracket 204 comprises a plurality of mounting points 301a-d at opposing ends for mounting the bracket 204 to an engine support structure (shown in FIG. 7a) or vehicle chassis, for example using a corresponding plurality of bolts through the mounting points 301a-d to secure the bracket to the engine support structure. A strap 302 extends around the filter housing 208 to secure the filter 203 to the rotatable filter mount 210. Other components are as described above in relation to FIG. 1.

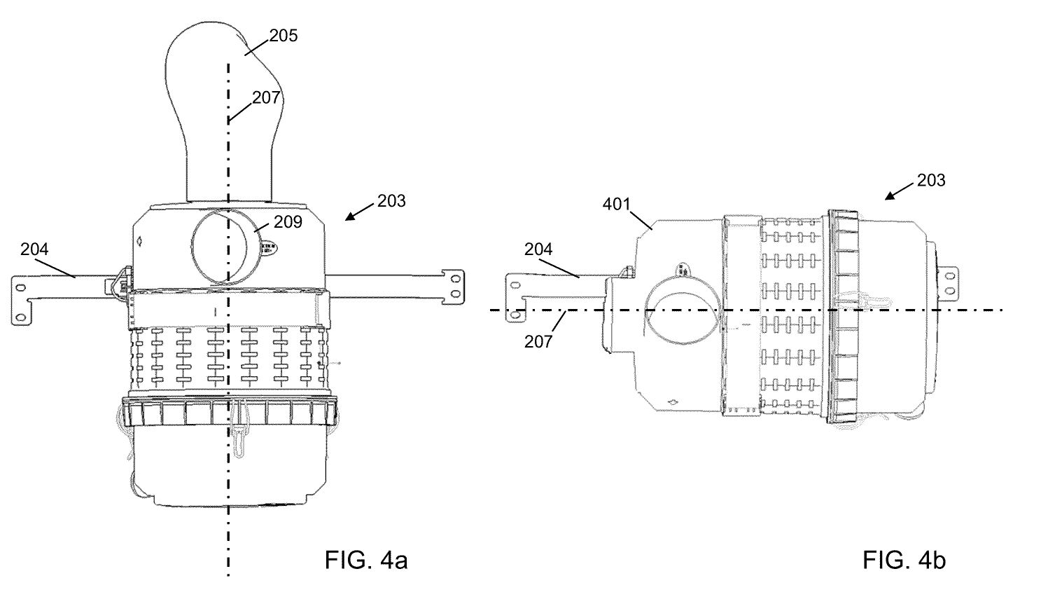

FIG. 4a is a front elevation view drawing of the filter 203 and bracket 204, with the filter 203 in a first, or operational, orientation in which the longitudinal axis 207 of the filter 203 is oriented generally vertically in relation to an upright orientation of the vehicle in use. Following disconnection of the filter outlet 205 and filter inlet 209, the filter 203 can be rotated relative to the bracket 204 about the rotation axis of the rotatable filter mount 210 to the orientation shown in FIG. 4b, in which the longitudinal axis 207 of the filter 203 is oriented generally horizontally. This second, or maintenance, orientation of the filter 203 allows for easier access to the filter 203 to allow for maintenance. Maintenance may, for example, involve removal of a filter housing cap 401 to enable an internal filter component to be removed and replaced. The filter 203 can then be reoriented to the first position in FIG. 4a, and the inlet 209 and outlet 205 reconnected.

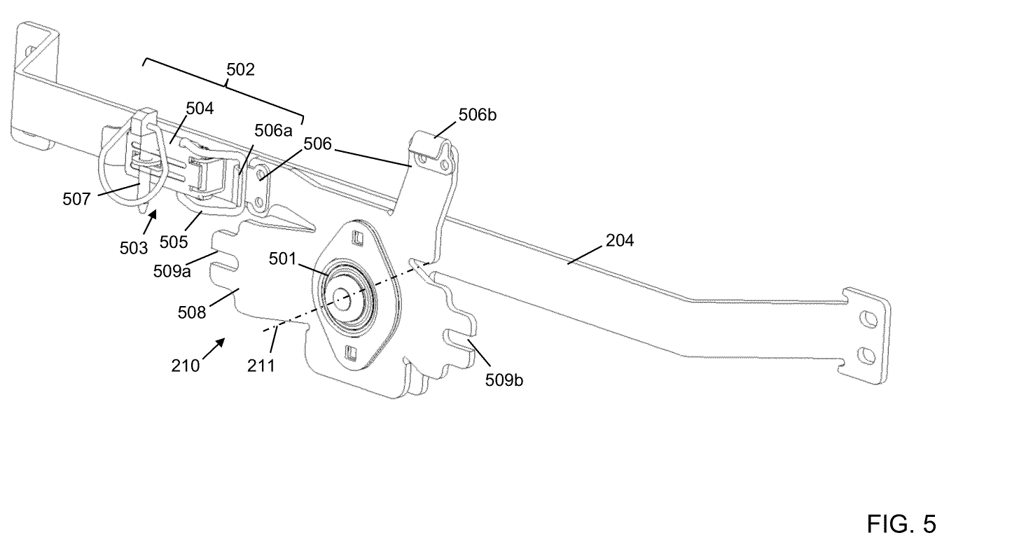

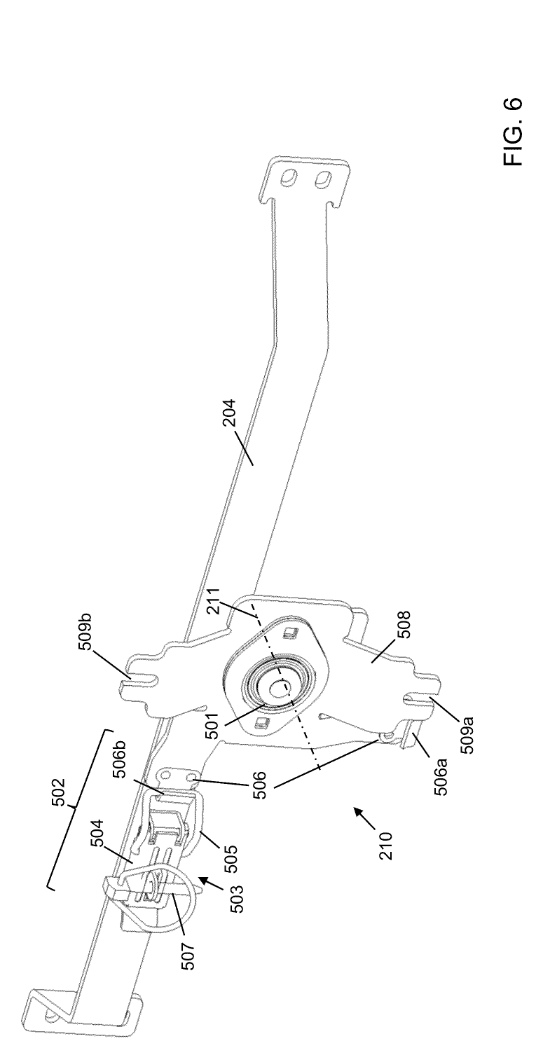

FIG. 5 illustrates the bracket 204 and rotatable filter mount 210 in further detail, with the filter removed to illustrate details of the rotatable filter mount 210 and associated connections to the bracket 204. The filter mount 210 is connected to the bracket 204 about a bearing 501, enabling the filter mount 210 to rotate relative to the bracket 204 around the rotation axis 211. To enable the filter mount 210 to be secured in both the first and second orientations, a clamping mechanism 502 is provided that is configured to secure the filter mount 210 to the bracket 204 in the first, and optionally also the second, orientation. FIG. 5 illustrates the filter mount 210 in the first orientation and FIG. 6 illustrates the filter mount 210 in the second orientation, in which the filter mount 210 is rotated around 90 degrees relative to the first orientation about the rotation axis 211. The clamping mechanism 502 in the example in FIG. 5 and FIG. 6 is in the form of a toggle latch 502 having a first part 503 with a lever 504 and loop 505 attached to the bracket 204 and a second part 506 on the filter mount 210. The second part 506 comprises first and second hooks 506a, 506b that are connectable to the first part 503 with the filter mount 210 in the respective first and second orientations. The filter mount 210 can thereby be readily releasably secured for ease of maintenance. A locking pin 507 may be provided on the first part 503 to secure the lever 504 in position to prevent the latch 502 becoming loose as a result of vibration during operation.

The rotatable filter mount 210 further comprises a mounting plate 508 having first and second mounting points 509a, 509b to enable the filter mount 210 to be secured to the filter housing. In the example illustrated in FIG. 5, the mounting points 509a, 509b are in the form of slots for securing the filter mount 210 to the filter housing with bolts, either directly or via a strap 302 of the type illustrated in FIG. 3.

FIG. 7a is a front elevation view drawing of an example vehicle engine assembly 700 comprising an assembly of the type described above mounted within an engine support structure 704. In FIG. 7a the filter 203 is shown in the first, or operational, orientation. FIG. 7b is a further front elevation view drawing of the vehicle engine assembly 700 with the filter 203 in the second, or maintenance, orientation. FIG. 7c is a further front elevation view drawing of the vehicle engine assembly 700 with the filter removed. The unobstructed area of the heat exchanger assembly 201 is indicated in each of the drawings, with FIG. 7a showing an unobstructed area in two parts 701a, 701b either side of the filter 203 that together amount to an area of 80,850 mm², in FIG. 7b with an unobstructed area 702 amounting to 37,500 mm² and in FIG. 7c with an unobstructed area 703 amounting to 153,750 mm². Orienting the filter 203 in the first orientation in FIG. 7a thereby more than doubles the unobstructed area available for airflow through the heat exchanger assembly 201, enabling a cooling airflow to flow more freely through the heat exchanger assembly 201.

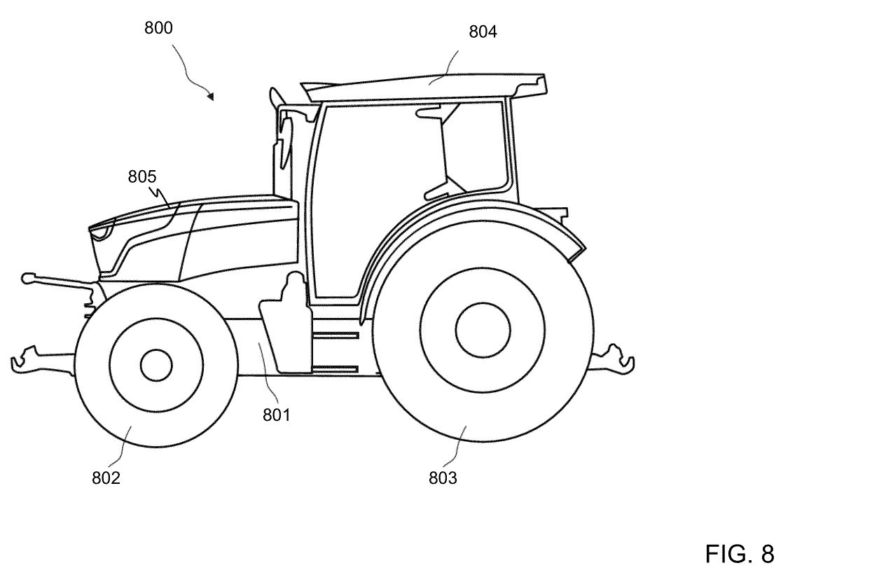

FIG. 8 is a schematic drawing of an example vehicle 800, in this case a tractor, that may comprise a vehicle engine assembly 700 as described above. The vehicle 800 comprises a chassis 801 supporting front and rear wheels 802, 803. A cab 804 is provided towards a rear of the vehicle for a driver to operate the vehicle 800. An engine compartment 805 towards a front end of the tractor 800 encloses the vehicle engine assembly 700. Other arrangements are also possible, for example a rear mounted engine assembly in alternative configurations.

1. An assembly for a vehicle, comprising:
a heat exchanger assembly having a first face;
an engine air intake filter having a housing;
a bracket extending across the first face of the heat exchanger assembly; and
a filter mount rotatably connected to the bracket and coupled to the housing of the air intake filter,
wherein the filter mount is rotatable relative to the bracket about a rotation axis orthogonal to the first face of the heat exchanger assembly.

2. The assembly of claim 1, wherein the filter mount is rotatable between first and second orientations, wherein the housing of the air intake filter obscures a smaller area of the first face of the heat exchanger assembly in the first orientation.

3. The assembly of claim 2, wherein the filter housing has a generally cylindrical shape, a longitudinal axis of the filter housing (208) being oriented vertically in the first orientation.

4. The assembly of claim 3, wherein the longitudinal axis of the filter housing is oriented horizontally in the second orientation.

5. The assembly of claim 1, wherein the air intake filter comprises a detachable air inlet and a detachable air outlet.

6. The assembly of claim 1, wherein the housing of the air intake filter comprises a removable cap.

7. The assembly of claim 1, wherein the filter mount is connected to the bracket about a bearing.

8. The assembly of claim 1, comprising a clamping mechanism configured to secure the filter mount to the bracket in the first orientation.

9. The assembly of claim 8, wherein the clamping mechanism is configured to secure the mount to the bracket in the second orientation.

10. The assembly of claim 8, wherein the clamping mechanism comprises a toggle latch.

11. The assembly of claim 10, wherein the toggle latch comprises a first part with a lever and loop attached to the bracket and a second part comprising a hook attached to the filter mount.

12. The assembly of claim 11, wherein the second part of the toggle latch comprises a first hook connectable to the first part with the filter mount in the first orientation and a second hook connectable to the first part with the filter mount in the second orientation.

13. The assembly of claim 1, wherein the clamping mechanism comprises a locking pin configured to secure the first part in position.

14. The assembly of claim 1, wherein the filter mount comprises a mounting plate having first and second mounting points to secure the mounting plate to the filter housing.

15. The assembly of claim 1, wherein the filter comprises a strap extending around the filter housing and configured to connect to the mounting plate.

16. A vehicle engine assembly comprising the assembly of claim 1.

17. The vehicle engine assembly of claim 16, wherein the engine assembly comprises an engine support structure, the bracket being attached to the engine support structure at opposing ends of the bracket.

18. A vehicle comprising the vehicle engine assembly of claim 17.

19. The vehicle of claim 18, wherein the vehicle is a tractor.
